(19) United States
(12) Patent Application Publication
(10) Pub. No.: US 2011/0227833 A1
(43) Pub. Date: Sep. 22, 2011

(54) DISPLAY AND OPERATOR CONTROL APPARATUS

(75) Inventors: Kai Jungclaus, Paderborn (DE); Dieter Schliebe, Bad Wuennenberg (DE)

(73) Assignee: WINCOR NIXDORF INTERNATIONAL GMBH, Paderborn (DE)

(21) Appl. No.: 13/130,662

(22) PCT Filed: Dec. 2, 2009
(86) PCT No.: PCT/EP2009/008566

§ 371 Date: May 23, 2011

(30) Foreign Application Priority Data
Dec. 11, 2008 (DE) 10 2008 061 831.4

(51) Int. Cl. G06F 3/02

(52) U.S. Cl. 345/168

(57) ABSTRACT

The invention relates to a display and operator control apparatus having a touch-sensitive screen and a signal processing unit with the following features: an interface unit for receiving display data and for sending position data captured on the touch-sensitive screen, means for processing display data from a first display object which represents a screen keypad with screen keypad elements, means for assigning the position data captured to a keypad element on the screen keypad, where means are provided for converting the position data into keypad code data and vice versa, such that the interface unit can be used in a screen keypad mode, in which the screen keypad can be shown on the display unit, to send the keypad code data, and that the position data are sent in a non-keypad mode in which the screen keypad cannot be shown on the display unit.

### CROSS-REFERENCE TO RELATED APPLICATIONS

This application is a National Stage of International Application No. PCT/EP2009/008566, filed Dec. 2, 2009. This application claims the benefit and priority of German application 10 2008 061 831.4, filed Dec. 11, 2008. The entire disclosures of the above applications are incorporated herein by reference.

### BACKGROUND

This section provides background information related to the present disclosure which is not necessarily prior art.

### TECHNICAL FIELD

The invention relates to a display and operator control apparatus having a touch-sensitive screen and a signal processing unit with the following features: an interface unit for receiving display data and for sending position data captured on the touch-sensitive screen, means for processing display data from a first display object that represents a screen keypad with keypad elements, means for assigning the position data captured to a keypad element of the screen keypad.

### DISCUSSION

A display and operator control apparatus is known from WO 02/061566 A1 with a touch-sensitive screen and a signal processing unit in which the signal processing unit has means so that a first display object can be visualized on the screen that represents a screen keypad with keys. This screen keypad covers the entire display area of the screen. The screen keypad is configured to be transparent so that a second display object is recognizable. Because the screen keypad can be shown, by touching the appropriate surface elements on the touch-sensitive screen the screen keypad can be used, for example, to change or set parameters shown in the second display object.

The disadvantage of the known display and operator control apparatus is that in order to process or evaluate the position data generated by touching the touch-sensitive screen, said data must be transmitted to a graphic card of a computer. It is thus always necessary to interpret the corresponding position data.

### SUMMARY OF THE INVENTION

It is an aspect of the present invention is to continue development of a display and user control apparatus in such a way that enables the usability of a screen keypad to be expanded in a simple manner.

The preferred embodiment of the invention is characterized in that means are provided to convert the position data into keypad code data and vice versa, in such a way that the keypad code data are sent over the interface unit in a screen keypad mode in which the screen keypad can be shown on the display unit, and the position data are sent in a non-screen keypad mode, in which the screen keypad cannot be shown on the display unit.

In accordance with the invention, a signal processing unit assigned to the touch-sensitive screen has means for converting position data into keypad code data so that in a screen keypad mode of the display and operator control apparatus, in which a screen keypad is shown on the screen, only keypad code data are sent. In this screen keypad mode, the display and operator control apparatus behaves like a conventional physical keypad that is connected, for example, over a USB interface to the computer. The invention thus advantageously permits emulation of a physical keypad as an input device. An operator can advantageously make keypad entries at the display and operator control apparatus for service purposes as soon as the computer is booted. The invention makes it possible specifically to activate or deactivate a screen keypad mode regardless of the application software.

In accordance with a preferred embodiment of the invention, the signal processing unit comprises a display/control unit and a screen keypad control unit, wherein the screen keypad control unit is connectable to an input means for activating or deactivating at least one operating state. The screen keypad control unit comprises control means so that when the input means is actuated, the display and operator control apparatus is switched to the screen keypad state in which the screen keypad is displayed on the touch-sensitive screen and the corresponding keys can be actuated by touching said elements on the one part, and in which the position data of the touch-sensitive screen are converted into keypad code data for transmission to the computer. Because the display and operator control apparatus has the input means to activate or deactivate the different operating states on the one part and the screen keypad control unit on the other, it is possible to achieve an “autarchic” input and visualization of keys for actions assigned to the screen keypad, and this irrespective of the operating state of the computer. The screen keypad control unit processes the position data of the touch-sensitive display unit captured and makes said data available to the computer as keypad code data. The screen keypad mode can advantageously be activated at any time by an operator independently of the application so that it is superfluous to provide a physical keypad.

In accordance with another further development of the invention, the display control unit has control means so that a second display object is shown on the screen. The second display object preferably appears spatially separated from the first display object, that is to say no provision is made to have the first and the second display objects fade into each other. Since only those surface elements of the touch-sensitive screen can be actuated in the screen keypad mode that coincide with keys on the screen keypad, the result is a defined input of keypad elements. The screen keypad control unit represents a toggling function in which keypad code data are prepared in the screen keypad mode and in which position data for the touch-sensitive display unit are prepared in the non-screen keypad mode.

In accordance with a further development of the invention, the input means for activating or deactivating the screen keypad mode can be configured as an enter key that can be located on the touch-sensitive screen. The operator can thus advantageously activate or deactivate the screen keypad mode in a simple manner, regardless of the application program.

In accordance with a further development of the invention, the input means for activating or deactivating the screen keypad mode is shown as a third display object on the screen that, in conjunction with corresponding surface elements on the touch-sensitive screen, can be activated to switch from the non-screen keypad mode into the screen keypad mode and vice versa. The switch between the corresponding modes can be made by means of a suitable application program so that traditional touch-sensitive screens can be employed.

In accordance with a further development of the invention, the screen keypad control unit can be located integrally with the touch-sensitive screen. This creates an “intelligent” touch-sensitive screen that allows fonts, keypad codes or keypad layouts to be loaded. The screen keypad can be used independently of the computer's applications in the screen keypad mode. The touch-sensitive screen behaves like a physical keypad on the input side and can be connected to the computer over a suitable commercially available interface, such as a USB interface.

### BRIEF DESCRIPTION OF THE DRAWINGS

One embodiment of the invention is explained in more detail using the drawings.

The drawings described herein are for illustrative purposes only of selected embodiments and not all possible implementations, and are not intended to limit the scope of the present disclosure.

FIG. 1 shows a block diagram of a display and operator control apparatus in accordance with the invention and

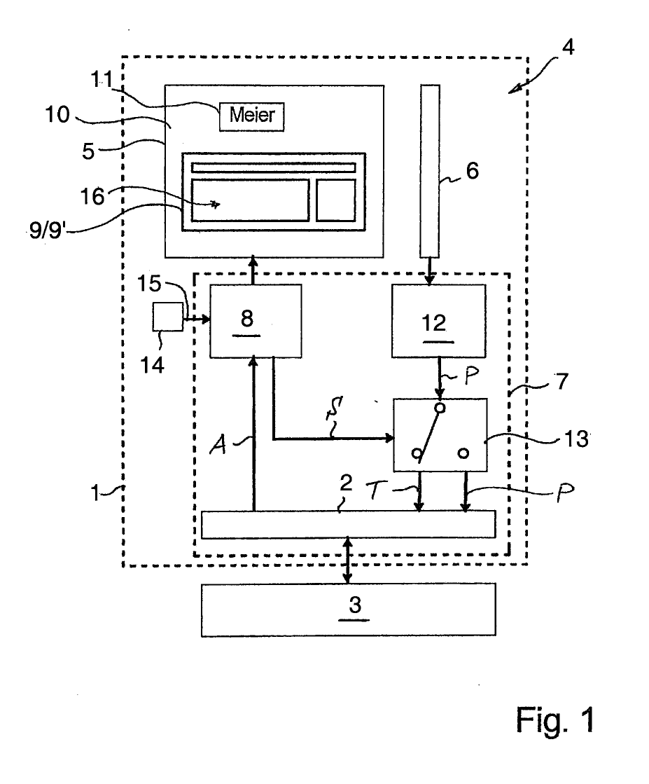

FIG. 2 shows a flow chart when using the screen keypad mode.

Corresponding reference numerals indicate corresponding parts throughout the several views of the drawings.

### DETAILED DESCRIPTION OF THE PREFERRED EMBODIMENTS

Example embodiments will now be described more fully with reference to the accompanying drawings.

A display and operator control apparatus in accordance with the invention 1 can be used in cash register systems for completing sales or payment transactions in supermarkets, for example, and it is connected over an interface unit 2 to a cash register system computer 3. The computer 3 is used for the electronic processing of data relevant to payments and is connected, for example, to a cash register printer, barcode scanner, cash drawer, etc. over suitable terminals.

In the present embodiment, the computer 3 is not connected to a cash register keypad. Instead, the display/operator control apparatus 1 has a touch sensitive screen 4 that consists firstly of a display unit 5 (LCD display) and secondly of a touch-sensitive surface unit 6 (touchscreen). The display/operator control apparatus 1 has in addition a signal processing unit 7 in which the following functions are integrated. First of all, the signal processing unit 7 has a display control unit 8 assigned to the display unit 5 that processes the display data A transmitted by the computer 3 and converts said data in such a way that, for example, a first display object 9, a second display object 10 and a third display object 11 can be shown.

The signal processing unit 7 furthermore includes a touch screen control unit 12 in which the signals received by the touch-sensitive surface unit (touchscreen 6) are converted into position data P.

The signal processing unit 7 further includes a screen keypad control unit 13 in which the position data P output by the touch screen control unit 12 are processed.

The invention provides input means to activate or deactivate a screen keypad mode to enter data into the touch-sensitive screen 4 by means of a screen keypad 9′ shown on the display unit 5. An enter key 14 integrated into a surround of the display unit 5 acts as the input means in the present embodiment.

The touch-sensitive screen 4 is suitable for entering data interactively with a cash register operating program in the usual way by touching surface elements on the touch-sensitive surface unit 6 with a pen (entry aid) or the operator's finger. In this process, the position data P (x-y coordinates) for the touch-sensitive surface unit 6 generated as a result of actuating the surface elements are transmitted to the computer 3 by assigning said position data to specified program functions. This assignment is carried out as a function of the position data P and the display data A shown at the same time in the display unit 5. During this process, the display/operator control apparatus 1 is in a non-screen keypad mode, in which the position data P are transmitted from the screen keypad control unit 13 to the computer 3 over the interface unit 2 (a USB interface for example).

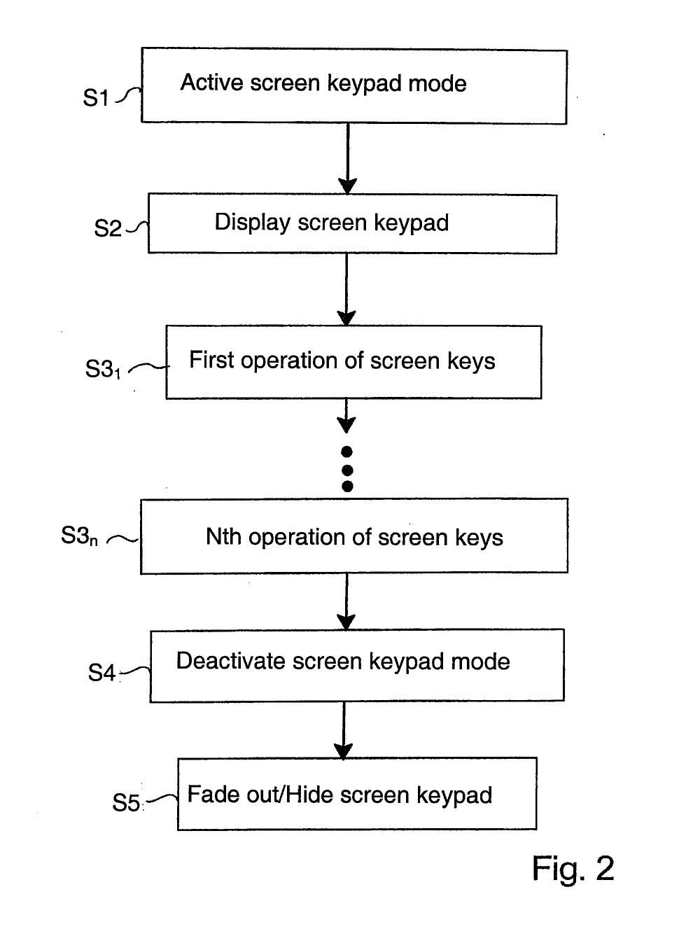

The sequence for activating or deactivating the screen keypad mode is explained in more detail using FIG. 2. The screen keypad mode is activated in a first step S1 by the enter key 14. The input signal 15 generated by the enter key 14 is passed on in the signal processing unit 7 to the display control unit 8 in which a command signal S is generated that is sent to an input of the screen keypad control unit 13. When the command signal S to activate the screen keypad is given, the position data P provided in the screen keypad control unit 13 by the touchscreen control unit 2 are converted by suitable processing means into the keypad code data T (scan code) that are transmitted over the USB interface 2 to the computer 3. In addition, the display data A provided by the computer 3 are modified in such a manner that the screen keypad 9′ is displayed in the first display object 9 of the display unit 5, S2. The screen keypad 9′ is (thus) shown in the existing second display object (complete display area 10) of the display unit 5.

In the screen keypad mode that is now present, the touch-sensitive surface unit 5 serves only to enter position data corresponding to keys 16 on the screen keypad 9′. Said position data are transmitted to the computer 3 as key code data T so that the effect of the touch-sensitive screen 4, as a “virtual keypad”, on the computer 3 is like a conventional keypad with conventional keys. Only keypad code data T, no position data P, are transmitted to computer 3 in this screen keypad mode.

In the following steps S31, . . . S3n, the screen keypad 9′ can be used like a conventional keypad to enter data (alphanumeric characters, etc.). For example, during the booting process for the computer 3, by pressing the enter key 14 and thus activating the screen keypad mode on the touch-sensitive screen 4, data are entered that permit an operator to make entries in the BIOS of the computer 3.

An unscheduled entry of data by means of the screen keypad 9′ can also be made during check out by activating the screen keypad mode. To do this, the cash register program can be set up in such a way, for example, that at the same time screen 9′ is opened a third display object 11 is overlaid as a window so that the name of a customer “Meier” entered using the screen keypad 9′ can be displayed.

In accordance with an alternative embodiment not shown, the input means 14 can also be provided by means of the appropriate current program by displaying an additional fourth display object on the display unit 4. The display/operator control apparatus 1 can then be toggled between the non-screen keypad mode and the screen keypad mode and vice versa by touching the fourth display object.

As soon as the data have been entered by pressing the corresponding keys 16 on the screen keypad 9′ in accordance with steps S31, . . . S3n, the screen keypad mode can be deactivated or the non-screen keypad mode can be activated by pressing the enter key 14 in step S4. To do this, the display unit 5 generates an appropriate control command S, the effect of which is that only position data P are passed on to the computer 3 in the screen control unit 13. In addition, the display data A are modified in such a manner that the screen keypad 9′ from the second display object 10 is hidden (S5). The display/operator control apparatus 1 is now once more in the non-screen keypad mode.

In accordance with an alternative embodiment not shown, one part or all of the control means contained in the display control unit 8, touchscreen unit 12 and screen keypad control unit 13 can be located as a common unit, not as separate units. For example, the signal processing unit 7 thus created can be integrated in the housing of the touch-sensitive screen 4 or can be connectable as a separate unit to the touch-sensitive screen 4 and the computer 3.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed:

1. Display and operator control apparatus having a touch-sensitive screen and a signal processing unit with the following features:
an interface unit for receiving display data and for sending position data captured on the touch-sensitive screen,
means for preparing display data for a first display object that represents a screen keypad with keypad elements,
means for assigning the position data captured to a keypad element of the screen keypad,
characterized by means (13) for converting the position data (P) into keypad code data (T) and vice versa, such that the keypad code data (T) are sent over the interface unit (2) in a screen keypad mode in which the screen keypad (9′) can be shown on the display unit (5), and such that the position data (P) are sent in a non-screen keypad mode in which the screen keypad (9′) cannot be shown on the display unit (5).

2. Display and operator control apparatus from claim 1, wherein the signal processing unit (7) has a screen keypad control unit (13) as means for converting the position data (P) into keypad code data (T) and vice versa, where, on the one hand, as a function of a control command (S) in screen keypad mode the input-side position data (P) are converted into keypad code data (T) and then the keypad code data (T) are passed on, and (on the other hand) in non-keypad mode only the input-side position data (P) are passed on.

3. Display and operator control apparatus from claim 1 or 2, wherein entry means (4) are assigned to the signal processing unit (7) to activate or deactivate the screen keypad so that the control command (S) can be applied at the input of the screen keypad control unit (13).

4. Display and operator control apparatus from one of the claims 1 to 3, wherein control means are provided such that when the screen keypad status is activated, the display data (A) are modified in such a way that the screen keypad (9′) is superimposed as the first display object (9) on an existing second display object (10) of the display unit (5).

5. Display and operator control apparatus from one of the claims 1 to 4, wherein the screen keypad control unit (13) comprises means so that only the surface elements of the touch-sensitive surface unit (6) corresponding to keys (16) of the screen keypad (9′) can be processed and are transmitted to a computer (3) as keypad code data (T).

6. Display and operator control apparatus from one of the claims 1 to 5, wherein the input means (14) for activating or deactivating the screen keypad mode is configured as an enter key located on the touch-sensitive screen (4).

7. Display and operator control apparatus from one of the claims 1 to 6, wherein the touch-sensitive screen (4) has a touch-sensitive surface unit (6) to which a touchscreen control unit (12) for processing the position data (P) captured by surface elements of the surface unit (6) is assigned in the signal processing unit (7).

8. Use of a display and operator control apparatus from one of the claims 1 to 7 for a cash register system.
